(19) United States
(12) Patent Application Publication
(10) Pub. No.: US 2005/0288012 A1
(43) Pub. Date: Dec. 29, 2005

(54) Timing compensation method and means for a terrestrial wireless communication system having satelite backhaul link

(76) Inventor: William Morgan, Marengo, IL (US)

Correspondence Address: MOTOROLA, INC., 1303 EAST ALGONQUIN ROAD, IL01/3RD, SCHAUMBURG, IL, 60196, US

(21) Appl. No.: 10/874,425

(22) Filed: Jun. 23, 2004

(51) Int. Cl. H04Q 7/20

(52) U.S. Cl. 455/428; 455/13.2

(57) ABSTRACT

A technique for timing compensation is used in a terrestrial wireless communication system (300) that has a satellite backhaul link (352, 358, 360) to at least one base transceiver station (306, 307, 308). The technique includes establishing a backhaul delay (BHD) of the satellite backhaul link and performing at least one timing compensation function based on the backhaul delay. The technique further includes setting (540, 545) a base controller system time (170). The following timing compensation functions are described: adjustment of packet arrival timing error interval (520), selection of a mobile station power control outer loop path (525), adjustment of at least one protocol timer (530), evaluation of a reverse Markov test call frame based on the BHD and real time (545), adjustment of forward data frame alignment based on the BHD and real time (555), and adjustment of forward Markov test call frame generation based on the BHD and real time (560).

### FIELD OF THE INVENTION

The present invention relates generally to wireless communication systems and, in particular, to using satellite communications for backhaul links in a wireless communication system.

### BACKGROUND OF THE INVENTION

Wireless communication systems are well known and consist of many types including land mobile radio, cellular radiotelephone (inclusive of analog cellular, digital cellular, personal communication systems (PCS) and wideband digital cellular systems), and other communication system types. In cellular radiotelephone communication systems, for example, a number of communication cells are typically comprised of one or more Base Transceiver Stations (BTS's) coupled to one or more Base Station Controllers (BSCs) or Central Base Station Controllers (CBSCs), hereafter simply referred to as controllers and forming a Base Station Subsystem (BSS). The controllers are, in turn, coupled to a Mobile Switching Center (MSC) which provides a connection between the BSS and an external network, such as a Public Switched Telephone Network (PSTN), as well as interconnection to other BSSs. Each BTS provides communication services to a mobile station (MS) located in a coverage area serviced by the BTS via a communication resource that includes a forward link for transmitting signals to, and a reverse link for receiving signals from, the MS.

Fundamental to a wireless communication system is the ability to maintain established communication connections while an MS moves in and between coverage areas. In order to maintain established communication connections, ‘soft-handoff’ techniques have been developed for code division multiple access (CDMA) communication systems whereby an MS is in concurrent, active communication with multiple BTSs. Each BTS in active communication with the MS is a member of an ‘active set’ of the MS and transmits bearer traffic to, and receives bearer traffic from, the MS. As the MS moves through the communication system, BTSs are added to, or deleted from, the MS's active set so as to assure that the MS will always be in communication with at least one BTS.

Referring to FIG. 1, a block diagram of a CDMA wireless communication system 100 is shown in accordance with prior art communication systems. Communication system 100 includes a BSS 104 comprising multiple BTSs 106-108 that are each coupled to a controller 110 by terrestrial backhaul links 152, 154, 156 (which may include such link technologies as wireline, microwave, and optical). BSS 104 is coupled to an MSC 114 and MSC 114 is in turn coupled to an external network 116 and provides a communication link between the external network, or other BSSs, and BSS 104. Communication system 100 further includes an MS 102 that, for purposes of this example, is concurrently is in active communication with each of BTS 106 and 107. That is, MS 102 is in ‘soft-handoff’ with each of BTSs 106 and 107 and each of BTS 106 and BTS 107 is a member of an ‘active set’ of MS 102. As members of the active set of MS 102, each BTS of BTSs 106 and 107 concurrently maintains a respective wireless communication link 120, 130 with the MS. Each communication link 120, 130 includes a respective forward link 122, 132, for conveyance of signals to MS 102 and a respective reverse link 124, 134, for receipt of signals from the MS.

Each BTS 106, 107 in the active set of MS 102 conveys the same bearer traffic to, and receives the same bearer traffic from, the MS. By providing multiple BTSs that concurrently convey same signals to, and receive same signals, from MS 102, communication system 100 enhances the likelihood that the MS will receive an acceptable quality signal from BSS 104 and that the BSS will receive an acceptable quality signal from the MS, in a well-known manner.

As MS 102 heads towards a coverage area, or sector, associated with BTS 108, MS 102 identifies BTS 108 as a viable communication link, and MS 102 may also determine that communication link 120 is no longer a viable communication link. MS 102 then requests that communication system 100 add BTS 108 to the MS's active set, that is, establish a communication link 140 associated with BTS 108, comprising forward link 142 and a reverse link 144, as an active communication link for transmitting data to, and receiving data from, MS 102, and drop BTS 106 from the active set, that is, terminate communication link 120. Upon receiving the request, BSS 104 drops BTS 106 from the active set of MS 102 and terminates, or drops, communication link 120 between MS 102 and BTS 106. The MS 102 remains in a soft hand off situation, but in a different active set.

In order to achieve the improvements that are possible by soft-handoff, and to avoid irritating disturbances in a voice conversation when the active set of BTSs changes, it is essential that forward data frames conveying digitized voice that are arriving at the MS 102 from the BTSs 106-108 are synchronous to within a small time difference. Forward data frames in a typical system may be 20 milliseconds (ms) long. Because the backhaul links can have unacceptable differences in their time delays (for example, up to 60 ms in typical situations), there is a mechanism in some current CDMA systems to provide the necessary synchronization in an efficient manner. Each BTS 106-108 in this type of communication system has a Base Transceiver Station System Time Function (BSTF) 155 that receives real time information from a Global Positioning System receiver 150 which is used by the BSTF 155 to maintain a Base Transceiver Station System Time (BST) that is very close to the local real time. Each BTS 106-108 also receives within each 20 ms forward data frame a 4 bit frame sequence number (FSN). Industry standards assign when each forward data frame is to be transmitted by a BTS with reference to real time, as a means of synchronizing frame transmissions from different BTSs. Thus, each BTS 106-108 can determine whether a forward data frame received from the controller 110 is being received at a desired arrival time that is determined from the system time assigned for transmission of the forward data frame, to within 16 times 20 ms, or within 320 ms. When a forward data frame arrives early with reference to the desired arrival time, a BTS can buffer the forward data frame until the real time assigned for its transmission, but it will be appreciated that such buffering uses up resources within the BTS. When a forward data frame arrives substantially later than the desired arrival time, a BTS discards it, causing retransmissions and lower system throughput. If a forward data frame is advanced or delayed by more than 160 ms, the ambiguity imposed by the limited size (4 bits) of the FSN will prevent the BTS from making an accurate determination of the actual delay of the forward data frame with reference to the desired arrival time. However, since typical delays in the terrestrial backhauls are in the 20 to 80 ms range, this ambiguity problem does not arise in typical CDMA systems.

The controller 110 includes a Selection and Distribution Unit (SDU) 112 that selects data frames from those received from BTSs that are forwarded by the controller 110 to the MSC 114, and the SDU 112 also distributes data frames from the controller 110 to the BTSs. The SDU 112 comprises a Controller System Time Function (CSTF) 115 that maintains a base controller system time (BCST) 170 and a forward data frame offset 180-182 (FDFO1, FDFO 2, FDFO 3) for each BTS 106-108. The BCST 170 is maintained using a signal (such as a crystal referenced 100 microsecond time base) generated by a timer 117 that is coupled to the CSTF 115. In some systems BCST 170 may be set using real time information obtained over a backhaul link from a BTS, but it will be appreciated that due to delay incurred over the backhaul, the BCST 170 is not set exactly to real time. In these conventional systems, the backhaul delay is typically much less than 300 milliseconds, and the errors that might otherwise be caused by such delays are accommodated by correction mechanisms that include the FDFO 180, 181, 182, and timeouts. In other systems, the BCST 170 may be set using a real time value that is obtained by a receiver, such as a GPS receiver, that is within the controller 110 coupled to the controller 110 so that the time of the BCST 170 is set to the same time the BTS is using. Each BTS 106-108 informs the controller 110 of the amount of difference between the desired forward data frame arrival time and the actual forward data frame arrival time (the forward frame offset), using a 6 bit Packet Arrival Timing Error (PATE) value (in this example, a positive PATE value represents a delay of the arrival time of the forward data frame with reference to the desired arrival time). The PATE values, are sent to the controller 110 at intervals of 20 msec. The CSTF 115 adjusts the FDFO associated with a BTS by the duration indicted by 20 ms integer multiples in PATE received from the BTS. The controller 110 adjusts the BCST 170 by adding the amount of the delay indicated by the FDFO to the BCST 170 and uses the adjusted time to transmit forward data frames. As a result, the actual transmission times of forward data frames by the controller 110 for each terrestrial backhaul link 152, 154, 156 are quickly adjusted so that the arrival times at the designated BTS 106-108 are at least within 1 data frame of the desired arrival time. Incremental adjustments to the Frame Times smaller than 20 ms are further made (PATE can have resolution better than 20 ms), using other methods defined in CDMA system standards which are implemented in the protocol of current CDMA systems.

Referring to FIG. 2, a timing diagram shows an example of a sequence of forward data frames 205 arriving at a BTS, in accordance with communication systems described herein. The desired arrival times for frames 0 to 4, which are based on the real time measured at the BTS are shown on the horizontal axis. The actual arrival time is determined at a predetermined point 210 within each received data frame. In this example, the arrival time is delayed by more than 3 frame durations but less than 4, so the PATE sent by the BTS would be 3. Other incremental adjustments would then be made using conventional methods to bring the predetermined point 210 closer to the desired arrival time

Aspects of system functionality other than soft-handoff are also affected by backhaul delay. Call processing messages that contain action times are one example. One type of call processing message is a service negotiation to a new rate set—i.e., a change of the vocoder used to encode voice information. The MS 102, the BTSs in the active set, and the SDU coupled to the BTSs in the active set need to switch the new rate set at the same time to avoid failure of the call. This synchronization requires accommodation of backhaul delays. Another aspect that is affected is RF power control of the MS transmit power, which in many systems is setup to be handled by the CBSC using an outer control loop function and by each base station using an inner control loop function. When the backhaul delay becomes long enough, this outer control loop will become ineffective and can become detrimental due to loop instability. Yet another aspect of system functionality that is affected by backhaul delay are some timeout values that are dependent on assumed maximum one-way backhaul delays on the order of 100 msec. For example, a time-out delay which, when exceeded, indicates a failure of a forward data frame to have been acknowledged by a mobile station, may be on the order of 300 msec in a conventional system. If the two way backhaul delay becomes large enough, all forward data frames may fail.

It would be desirable to use satellite backhaul links in cellular systems in situations where conventional backhaul techniques are too costly—for example to support one or more cells in remote mountainous areas, or one cell on an oil platform, but a satellite backhaul link imposes a typical delay on the order of 500 ms, which is beyond the delays that can be accommodated by standard systems. Some reduction of system features and performance may be acceptable to users in such areas, but what is needed is a method to provide an acceptable level of service for users who are in regions where satellite backhaul is more practical than terrestrial backhaul.

### BRIEF DESCRIPTION OF THE DRAWINGS

The present invention is illustrated by way of example and not limitation in the accompanying figures, in which like references indicate similar elements, and in which:

FIG. 1 is a block diagram showing a CDMA wireless communication system, in accordance with prior art communication systems;

FIG. 2 is a timing diagram showing an example of a sequence of forward data frames arriving at a base transmitting station, in accordance with prior art communication systems;

FIG. 3 is a block diagram showing a CDMA wireless communication system, in accordance with some embodiments of the present invention;

FIG. 4 is a timing diagram showing an example of frame alignment in a terrestrial CDMA wireless communication system having at least one satellite backhaul link, in accordance with some embodiments of the present invention; and

FIGS. 5-12 are flow charts that show some steps of a timing compensation method used in a terrestrial wireless communication system having at least one satellite backhaul link, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail the particular method of timing adjustment in accordance with the present invention, it should be observed that the present invention resides primarily in combinations of method steps and apparatus components related radio communication systems. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

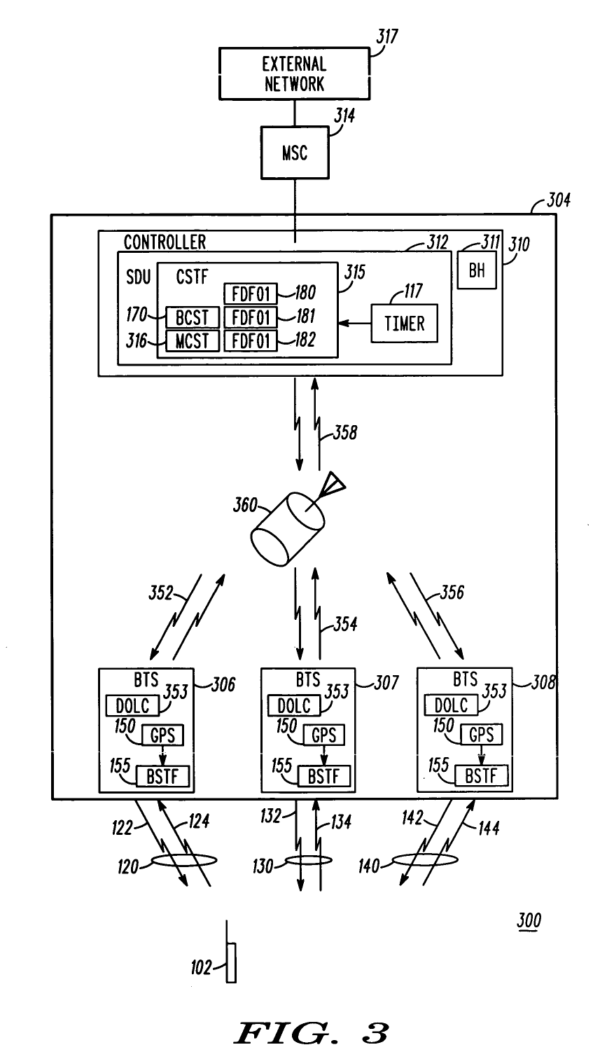

Referring to FIG. 3, a block diagram of a CDMA wireless communication system 300 is shown, in accordance with an embodiment of the present invention. Similar to communication system 100, communication system 300 includes a Base Station Subsystem (BSS) 304 comprising multiple Base Transceiver Stations (BTSs) 306-308 that are each coupled to a base controller 310, such as a Base Station Controller (BSC) or a Controller Base Station Controller (CBSC). BSS 304 is coupled to a mobile switching center (MSC) 314 and MSC 314 is in turn coupled to an external network 317 and provides a communication link between the external network 317, or other BSSs (not shown), and BSS 304. BSS 304 and MSC 314 may collectively be referred to as a portion of a fixed network of communication system 300. The BTSs 306-308 are coupled to the base controller 310 by a satellite backhaul system that comprises at least one geostationary satellite 360. Each BTS 306-308 is linked to the satellite 360 by a two way satellite radio link 352, 354, 356, and the satellite 360 is linked to the base controller 310 by a two way radio link 358. Thus, a composite link is established between each BTS 306-308 and the base controller 310 (e.g., the link from BTS 306 and the base controller 310 comprises the radio links 352, 358, and the satellite 360). Each of these composite links is called a satellite backhaul link (SBL) and has a typically one-way delay of approximately 500 msec. This delay exceeds the maximum delays accommodated by the standard design of current CDMA communication systems.

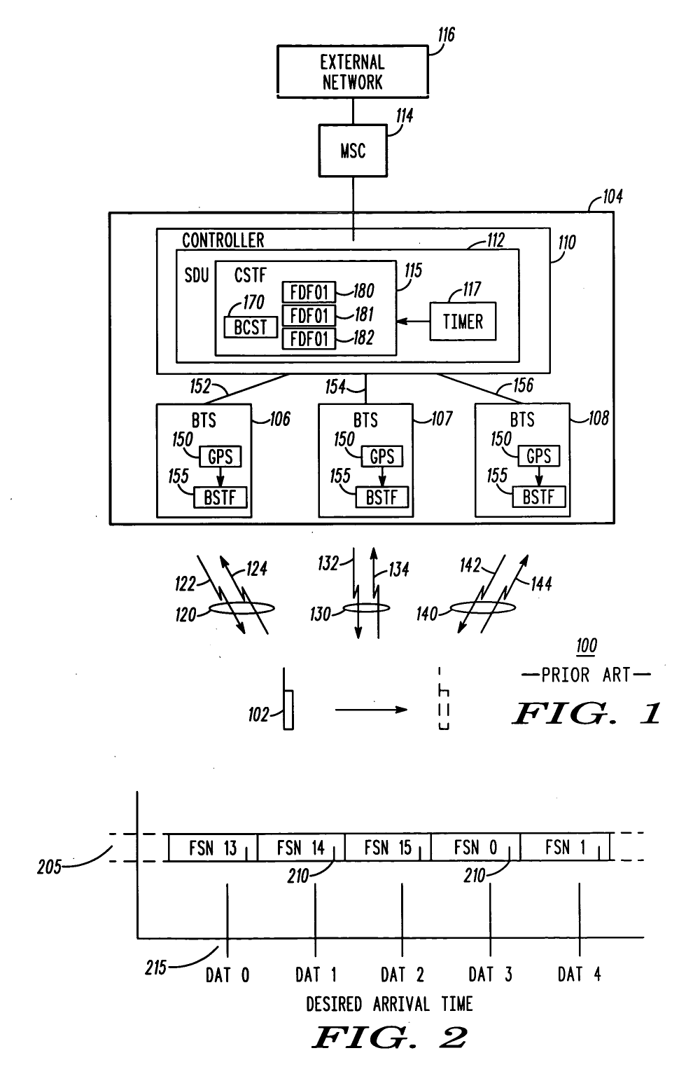

The controller 310 comprises a Selection and Distribution Unit (SDU) 312 that includes many functions of the controller 110 but has a combination of added unique functions and modified conventional functions that compensate timing aspects of the communication system related to long backhaul delays. The controller 310 comprises a Controller System Time Function (CSTF) 315 that is coupled to a timer 117 that may be the same timer 117 described above with reference to FIG. 1. The CSTF 315 generates the real time binary value that is identified herein as the base controller system time (BCST) 170 in a unique manner, but maintains forward data frame offsets (FDFOs) 180-182 using packet arrival timing error (PATE) values that arrive from each active BTS at intervals of approximately 20 msec in the same manner as described above. These values (the BCST 170 and PATE) are used in a unique manner described below to transmit data frames to the BTSs 306-308 so that the transmit data frames arrive at a BTS very close to the desired arrival time. In some embodiments, the CSTF 315 sets the BCST 170 using real time information obtained over a backhaul link from a BTS, but it will be appreciated that due to delay incurred over the satellite backhaul, the BCST 170 would be set to a time that differs from real time by an amount on the order of 500 msec., without the unique actions described herein. In other embodiments, the controller 312 comprises a Global Positioning System (GPS) receiver (not shown), which provides real time information to the CSTF 315, which uses the real time information to set the BCST 170. The CSTF 315 further maintains a modified controller system time (MCST) 170 that is obtained from the BCST 170 by a backhaul function (BH) 311. The backhaul function 311 determines a backhaul delay (BHD) that is a one-way delay of data frames over a backhaul link to one of the BTSs. The backhaul delay can be measured by known pinging techniques, such a roundtrip ping delay measurement from the controller to a chosen BTS, which would be divided by two. This backhaul measurement is a course measurement of a delay that actually varies somewhat over time, but the variance is small enough to be corrected by the standard forward data frame offsets 180-182 or accommodated by one or more unique time tolerance values established in accordance with the present invention. The backhaul delay or twice the backhaul delay may be uniquely used to generate the MCST 316 and in a variety of other techniques described below to compensate timing problems that would otherwise prevent successful operation of the communication system. The CSTF 315 performs other timing compensations as described below.

Each BTS 306-308 may comprise the Base System Time Function (BSTF) 155 and GPS receiver 150 as described above with reference to FIG. 1. The BSTF 155 generates a real time binary value that is identified herein as BST, and is driven by a time base that is not shown. Since each BSTF 155 may be coupled to a respective GPS receiver 150, BST can be a very accurate real time value. Each BTS also may uniquely comprise a distributed outer loop control function (DOLC) 153 that operates similarly to distributed mobile station power control functions in earlier version conventional communication systems. In accordance with one aspect of the present invention, when the backhaul delay is greater than a threshold value, for example 150 msec, use is made of the DOLC 353 in at least all those BTS's for which the backhaul delay exceeds that amount. The outer loop control of mobile station transmitting power is thereby performed in those BTSs instead of by a conventional controller outer loop control function (not shown the figures) within the controller 110. The outer loop control for mobile stations linking through BTSs that have a backhaul delay less than the threshold may remain under the control of the controller outer loop control function.

Communication system 300 further includes a mobile station (MS) 102 that may be concurrently in active communication with each BTS of multiple BTSs 306-308. That is, MS 102 may be in ‘soft-handoff’ mode with the multiple BTSs 306-308 and each BTS of the multiple BTSs 306-308 may be a member of an ‘active set’ of MS 302. As members of the active set of MS 302, each BTS of the multiple BTSs 306-308 concurrently maintains a respective wireless communication link 120, 130, 140 with the MS 102. Each communication link 120, 130, 140 includes a respective forward link 122, 132, 142 for conveyance of signals to MS 102 and a respective reverse link 124, 134, 144 for receipt of signals from the MS 102.

Preferably, communication system 300 is a Code Division Multiple Access (CDMA) communication system, in which each of forward links 122, 132, and 142 and reverse links 124, 134, and 144 comprises multiple communication channels, such as access channels, control channels, paging channels, and traffic channels. Each communication channel of a reverse link 124, 134, and 144 or a forward link 122, 132, and 142 comprises an orthogonal code, such as a Walsh Code, that may be transmitted in a same frequency bandwidth as the other channels of the link. However, those who are of ordinary skill in the art realize that communication system 300 may operate in accordance with any wireless telecommunication system, such as but not limited to a Global System for Mobile Communications (GSM) communication system, a Time Division Multiple Access (TDMA) communication system, a Frequency Division Multiple Access (FDMA) communication system, or an Orthogonal Frequency Division Multiple Access (OFDM) communication system. Communication system 300

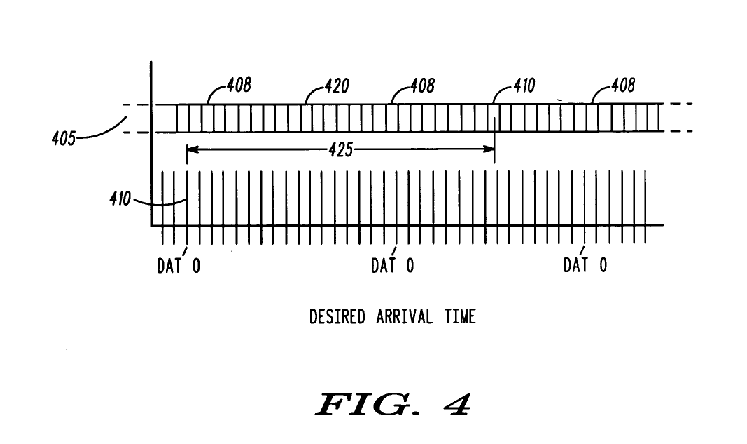

Referring to FIG. 4, a timing diagram shows an example of frame alignment in a terrestrial wireless communication system having at least one satellite backhaul link, in accordance with some embodiments of the present invention. A sequence of 20 msec forward data frames 405 arriving at a BTS are shown. Each small rectangle 420 of the sequence of data frames 405 represents a forward data frame. The sequence of forward data frames 405 has passed through a satellite backhaul link, which has caused a delay of approximately 490 msec, as indicated by the arrow 425 in FIG. 4. (The time scale in FIG. 4 is much larger than the time scale in FIG. 2). Forward data frame 410 is a forward data frame having a four bit frame sequence number (FSN) of decimal 0 (binary 0000). Forward data frame 420, which occurs 16 data frame times prior to forward data frame 410, also has FSN 0. Forward data frame 410 should be aligned with desired arrival time 0 before being transmitted by the BTS in order to facilitate such functions as soft handoff. A method for accomplishing this and other timing compensations is now described.

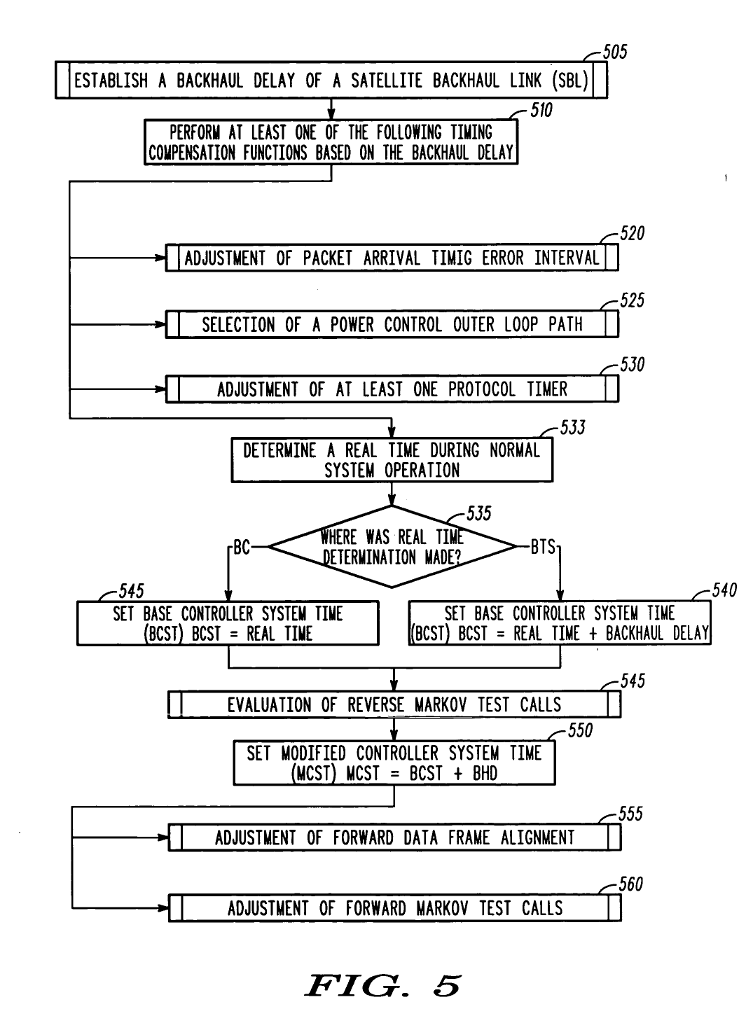

Referring to FIGS. 5-12, flow charts show some steps of a timing compensation method used in a terrestrial wireless communication system having at least one satellite backhaul link, in accordance with some embodiments of the present invention.

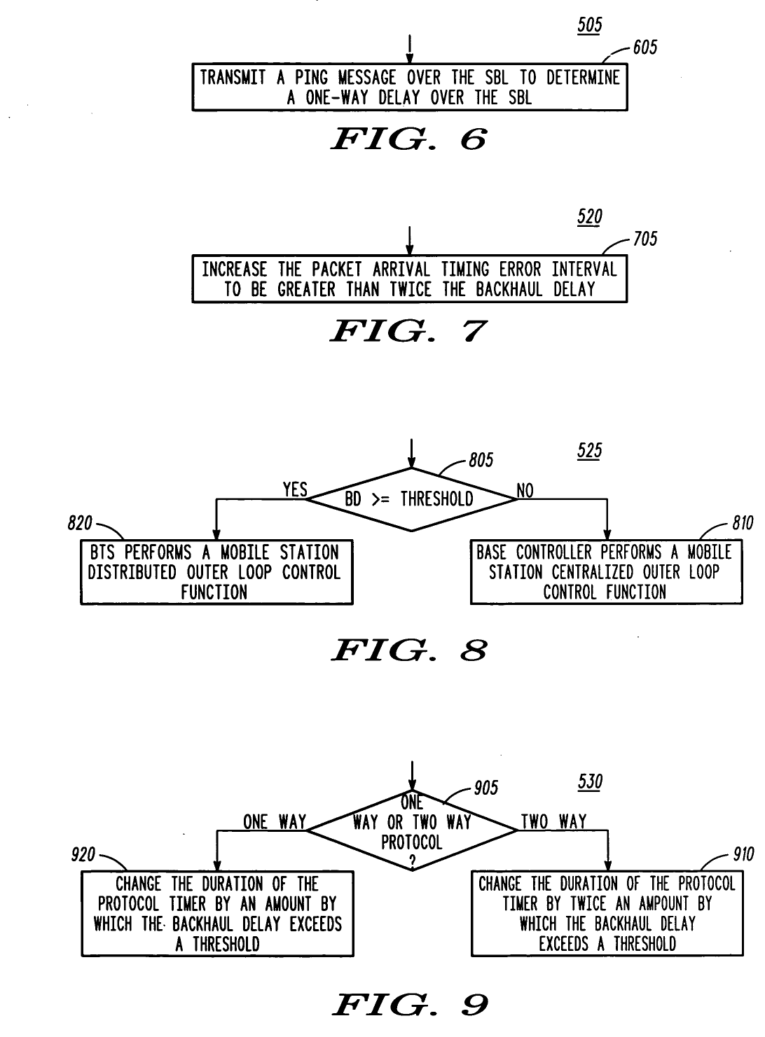

At step 505 of FIG. 5, a backhaul delay (BHD) of a satellite backhaul link (SBL) is established by the backhaul delay function (BH) 311 of the controller 310. This is a one way delay and may be established in a variety of ways, of which some conventional methods are illustrated in FIG. 6. Step 605 of FIG. 6 illustrates those conventional methods in which a ping message is sent over the SBL. These methods may include one in which a round trip ping message is sent from the controller to the BTS, and in which the BTS return the received ping message to the controller with extremely high priority (and therefore a small turn around delay). The ping turn around time may be known and subtracted from the total time before dividing the total time by two to determine the BHD, or the ping turn around time may be small enough to be ignored. In some systems, in which the BCST 170 is obtained by means of a GPS receiver at the controller site, a sufficiently accurate BHD may be obtained using a one way ping message that has a known transmit time. The BHD delay may be performed automatically at some time interval, and/or in response to an operator action, or at system set-up time. A choice of which to use may be dependent on a judgment of how much the BHD changes over time and may be dependent on the implementation of the timing compensation method.

A number of timing related functions may be compensated using the BHD established at step 505, as indicated by step 510. It may be that not all of these are needed for all systems, and the names of the functions may be different in different systems. Step 510 may be a design or operator selection of one or more timing compensation functions that are performed, based on the BHD measured at step 505.

At step 520 of FIG. 5, the packet arrival timing error interval is adjusted using the BHD, as further illustrated in FIG. 7. At step 705, the packet arrival timing error interval (the interval at which packet arrival timing errors are communicated from a BTS 306, 307, 308 to the controller 310) is increased from a conventional value that works in conventional systems to a value that is greater than twice the BHD. At step 525 of FIG. 5, a selection of a power control outer loop path is made, using the BHD, as further illustrated in FIG. 8. When the BHD is not greater than a defined threshold at step 805, the base controller 310 performs, at step 810, a mobile station centralized outer loop control function in the manner defined for standard systems that do not have large BHDs. When the BHD is greater than or equal to the defined threshold at step 805, the base controller 310 performs, at step 820, a mobile station distributed outer loop control function (DOLC) 353 that is uniquely added to the functions of the BTSs 306, 307, 308, which operates in a manner similar to mobile station control loops used in older conventional systems. This prevents instability of the outer control loop that might otherwise occur using the centralized outer loop control function with large BHDs. A threshold may be, for example, in the range of 100 to 350 milliseconds.

At step 530 of FIG. 5, an adjustment of at least one protocol timer is made, using the BHD, as further illustrated in FIG. 9. When the protocol timer is for a one way protocol, as determined at step 905, the duration of the protocol timer is increased at step 920 by an amount by which the BHD exceeds a threshold. When the protocol timer is for a two way protocol as determined at step 905, the duration of the protocol timer is increased at step 910 by twice an amount by which the BHD exceeds a threshold. A one way protocol is one for an action related to a transmission of information once over a BSL, whereas a two way protocol is one for an action related to a transmission of information twice over a BSL. An example of an action having a protocol delay that is modified in this manner is the T1 timer used in the HDLC (High-level Data Link Control) protocol. In other embodiments, the duration of the protocol timer may be changed to be once or twice the amount by which the BHD exceeds a threshold, instead of increasing the timer value by that amount. In other embodiments, the amount by which the timer is changed (or the amount to which it is changed in the other embodiments just described) may be simply once or twice the BHD (i.e., the threshold may be treated as being zero. A choice of an embodiment may be made depending on the relative values of the threshold, the conventional value of the protocol timer, and the typical BHD for systems operating with the present invention.

At step 533 of FIG. 5, a real time is determined. In some systems, the system time is determined at the controller 310, but in other systems the controller does not have the equipment, such as a GPS receiver, to determine the system time, so the system time is determined at one of the BTSs 306, 307, 308, and sent to the controller over a SBL. When the system configurations is one in which a BTS 306, 307, 308 determines a real time and sends it to a controller 310 (at step 535, which is typically a system design step, but which could alternatively be a fall back operational step), then the BCST 170 is set at step 540 to the real time obtained from the BTS 306, 307, 308 over a SBL, plus the BHD; i.e., BCST=real time from BTS+BHD. Thus, the time to which the BCST 170 is set is approximately equal to the real time at the site of the controller 310, with a setting error that is largely determined by any error made in measuring the BHD. When the system configurations is one in which a real time is determined at the site of the controller 310 (at step 535), then the BCST 170 is set to the real time obtained locally; i.e., BCST=real time obtained locally+BHD. In this instance, the time to which the BCST 170 is set is very close to the real time at the site of the controller 310. These steps to set the BCST 170 are typically made during normal system operation.

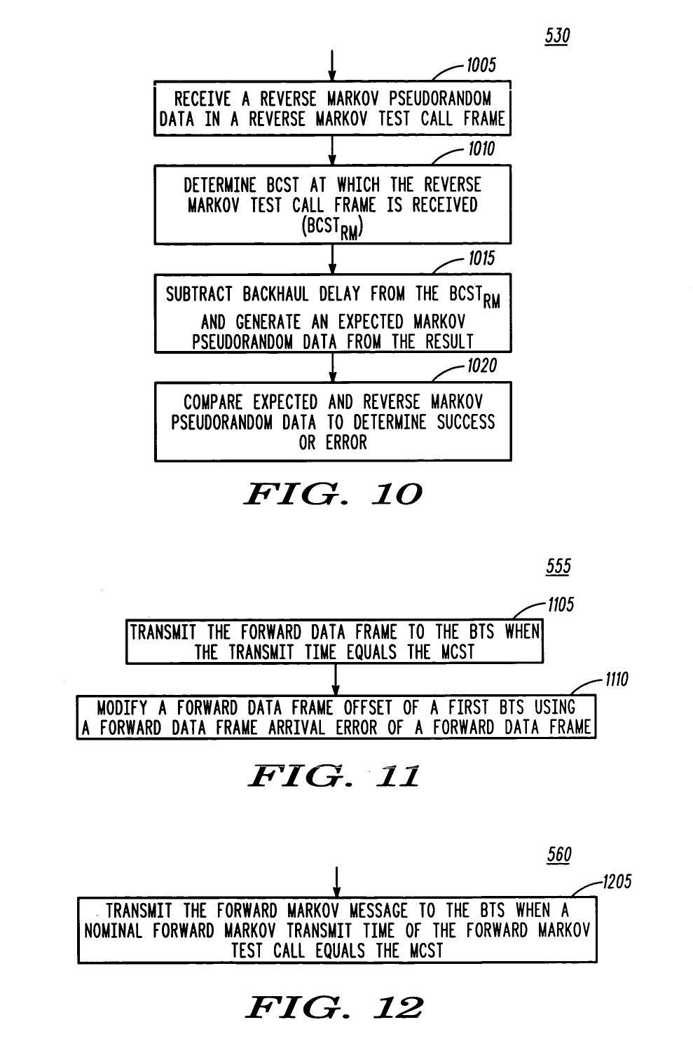

At step 545, reverse Markov test calls are evaluated using the BHD and real time, and in particular, the BHD and the BCST 170, as further illustrated in FIG. 10. As is known, reverse Markov test calls involve the transmitting of pseudorandom data in all frames of each reverse Markov test call. The pseudorandom data is a function of system time. The algorithm which generates the data uses the system time of each frame as a seed value. The MS 102 and the SDU 312 run the exact same algorithm. The SDU 312 can calculate exactly what pseudorandom data it should have received (an “expected Markov pseudorandom data”) and compare it to what was actually received (a “reverse Markov pseudorandom data”) over the channel. The overall successful frame reception statistics are compared to system design values in order to determine whether the system is operating as designed. The SDU 312 needs to determine a time the transmitting end should have used, within 20 ms resolution, when generating the pseudorandom data in the frame. When a reverse Markov test call frame is received at the controller 310 at step 1005, the BCST time at which the test call frame is received, which is defined herein as BCST_{RM}, is stored (even if only briefly) at step 1010. The BHD is subtracted from BCST_{RM} and the result is used at step 1015 as a system time to generate the expected Markov pseudorandom data. When the expected and reverse Markov pseudorandom data are the are different at step 1020, a frame error is recorded; otherwise no frame error is recorded. It will be appreciated that in systems in which the real time at the controller 310 is determined by a real time acquired at a BTS 306, 307, 308, reverse Markov test call frame success could alternatively be determined by maintaining a unmodified system controller time (UCST) (not shown in the figures) that is set directly from the real time received at the controller 310. Then the reverse Markov pseudorandom data could be compared with an expected Markov pseudorandom data generated from the UCST. For this particular aspect of system timing, the BHD would not need to be measured, but the USCT would have to be maintained.

At step 550 of FIG. 5, a modified base controller system time (MCST) 316 is set and maintained by the CSTF 315 of the controller 310. The CSTF 315 sets the MCST 316 to be equal to BCST−BHD.

At step 555 of FIG. 5, adjustment of forward data frame alignment is made using the MCST 316, as illustrated in more detail in FIG. 11. As is known, a forward frame is required in some systems to be transmitted at a time that is determined from a protocol identification of the frame, such as the frame number. This is accomplished in accordance with the present invention by sending the forward data frame, at step 1105, to the BTS which is identified for transmitting the forward data frame when the time determined by the protocol identification (also called herein the transmit time of the forward data frame) is equal to the MCST 316 plus the forward data frame arrival offset associated with the BTS. This is stated more generally as transmitting the forward data frame over the SBL to the BTS according to the frame sequence number of the forward data frame, the forward data frame offset of the BTS, and the modified controller system time. Even more generally, this may be stated as sending the forward data frame to the BTS based on the real time and the backhaul delay (since the transmit time is provided by info in the message, the MCST is determined from the BCST and the BHD, and the BCST may also be determined from the BHD). Thus, the forward frame is sent to the BTS one BHD ahead of real time so it arrives at the BTS approximately at the time at which it is to be actually transmitted. The forward data frame offset for a BTS is repetitively modified, as illustrated in step 1110, using a forward data frame arrival error that is measured by the BTS and communicated to the controller 310 using a packet arrival timing error (PATE) message. (As described above with reference to FIG. 7, the timing interval of the transmission of the PATEs to the controller 310 is reduced based on the BHD.)

At step 560 of FIG. 5, an adjustment of forward Markov test call is made using the BHD and real time, and more specifically using the BHD and the MCST 316, as described in more detail with reference to FIG. 12. In a manner similar to the reverse Markov test calls describe with reference to FIG. 10, a nominal forward Markov transmit time of each frame of a forward Markov text call is determined and used as a seed value to generate the pseudorandom data used within a frame of the forward Markov test call. Each frame of the forward Markov test call s transmitted to a BTS 306, 307, 308 at step 1205 when the modified controller system time 316 is equal to the forward Markov transmit time. Thus, the forward Markov test call is sent to the BTS one BHD ahead of real time so it arrives at the BTS approximately at the time at which it is to be actually transmitted.

It will be appreciated the timing compensation technology described herein may be implemented in a form comprising one or more conventional processors and unique stored program instructions that control the one or more processors to implement some, most, or all of the functions described herein as steps of a method. Alternatively, these functions could be implemented by a state machine that has no stored program instructions, in which each function or some combinations of certain of the functions are implemented as custom logic. Of course, a combination of the two approaches could be used. Thus, both methods and means for performing these functions have been described herein.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

A “set” as used herein, means a non-empty set (i.e., for the sets defined herein, comprising at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

It is further understood that the use of relational terms, if any, such as first and second, top and bottom, and the like may be used solely to distinguish one entity or action from another entity or action without necessarily requiring or implying any actual such relationship or order between such entities or actions.

1. A timing compensation method used in a terrestrial wireless communication system having at least one satellite backhaul link to at least one base transceiver station (BTS), comprising:
establishing a backhaul delay (BHD) of one of the at least one satellite backhaul link (SBL);
determining a real time;
setting a base controller system time to the real time;
generating a modified controller system time by adding the BHD to the base controller system time; and
transmitting a forward data frame over the one of the at least one SBL to the one of the at least one BTS according to a frame sequence number of the forward data frame, a forward data frame offset of the one of the at least one BTS, and the modified controller system time.

2. The timing compensation method according to claim 1, wherein the establishment of the backhaul delay further comprises transmission of one or more ping messages over the SBL to determine a one-way delay over the SBL.

3. The timing compensation method according to claim 1, wherein the terrestrial wireless communication system is a code division multiple access system.

4. The timing compensation method according to claim 1, wherein, when the real time has been determined by one of the at least one BTS, the setting of the base controller system time comprises:
receiving the real time in a message from the BTS; and
setting the base controller system time to the received real time minus the back haul delay.

5. The timing compensation method according to claim 1, wherein, when the real time has been determined by the base controller, the setting of the base controller system time comprises setting the base controller system time to the determined real time.

6. The timing compensation method according to claim 1, wherein the backhaul delay is greater than a maximum reportable range of forward data frame arrival offsets.

7. The timing compensation method according to claim 1, further comprising:
modifying a forward data frame offset of the one of the at least one BTS, using at least one forward data frame arrival time error that has been measured by the one of the at least one BTS.

8. A timing compensation method used in a terrestrial wireless communication system having at least one satellite backhaul link to at least one base transceiver station (BTS), comprising:
establishing a backhaul delay (BHD) of one of the at least one satellite backhaul link (SBL); and
performing at least one timing compensation function of a group of timing compensation functions based on the backhaul delay consisting of
adjustment of packet arrival timing error interval,
selection of a mobile station power control outer loop path,
adjustment of at least one protocol timer,
evaluation of a reverse Markov test call based on the BHD and real time,
adjustment of forward data frame alignment based on the BHD and real time, and
adjustment of forward Markov test calls based on the BHD and real time.

9. The timing compensation method according to claim 8, wherein the establishment of the backhaul delay uses transmission of one or more ping messages over the SBL to determine a one-way delay over the SBL.

10. The timing compensation method according to claim 8, wherein the terrestrial wireless communication system is a code division multiple access system.

11. The timing compensation method according to claim 8, wherein adjustment of packet arrival timing error interval further comprises increasing the packet arrival timing error interval to be greater than twice the BHD.

12. The timing compensation method according to claim 8, wherein selection of a mobile station power control outer loop path further comprises:
selecting a BTS to perform a mobile station distributed outer loop control function when the BHD is greater than a threshold value, and otherwise selecting a base controller to perform a mobile station centralized outer loop control function for the BTS.

13. The timing compensation method according to claim 8, wherein the adjustment of the at least one protocol timer comprises changing the duration of the at least one protocol timer by using a multiple of an amount by which the BHD exceeds a threshold, the multiple being one or two depending on whether the protocol of the at least one protocol timer is a one way or two way protocol.

14. The timing compensation method according to claim 8, further comprising:
determining a real time during normal system operation; and
setting a base controller system time essentially to the real time.

15. The timing compensation method according to claim 14, wherein, when the real time has been determined by one of the at least one BTS, the setting of the base controller system time comprises:
receiving the real time in a message from the BTS; and
setting the base controller system time to the received real time minus the back haul delay.

16. The timing compensation method according to claim 15, wherein, when the real time has been determined by the base controller, the base controller system time comprises setting a base controller system time to the determined real time.

17. The timing compensation method according to claim 15, wherein the backhaul delay is greater than a maximum reportable range of forward data frame arrival offsets.

18. The timing compensation method according to claim 15, wherein the evaluation of the reverse Markov test call further comprises receiving a reverse Markov pseudorandom data in a reverse Markov test call frame;
determining a base controller system time at which the reverse Markov test call is received, BCST_{M};
determining an expected Markov pseudorandom data from BCST_{M}−BHD;
determining a Markov test call frame success by comparing the expected and the reverse Markov pseudorandom data.

19. The timing compensation method according to claim 15, further comprising:
generating a modified controller system time by adding the backhaul delay to the base controller system time.

20. The timing compensation method according to claim 19, wherein adjustment of forward frame alignment comprises transmitting a forward data frame over the one of the at least one SBL to the one of the at least one BTS according to a frame sequence number of the forward data frame, a forward data frame offset of the one of the at least one BTS, and the modified controller system time.

21. The timing compensation method according to claim 19, wherein adjustment of timed remote event transmissions and forward Markov test calls comprises transmitting a forward Markov test call frame to the at least one BTS when the modified controller system time is at a nominal forward Markov transmit time of the Markov test call frame.

22. A means for timing compensation used in a terrestrial wireless communication system having at least one satellite backhaul link to at least one base transceiver station (BTS), comprising:
means for establishing a backhaul delay (BHD) of one of the at least one satellite backhaul link (SBL): and
means for performing at least one timing compensation function of a group of timing compensation functions based on the backhaul delay consisting of
adjustment of packet arrival timing error interval,
selection of a mobile station power control outer loop path,
adjustment of at least one protocol timer,
evaluation of a reverse Markov test call based on the BHD and real time,
adjustment of forward data frame alignment based on the BHD and real time, and
adjustment of forward Markov test calls based on the BHD and real time.
